(19) United States
(12) Patent Application Publication
(10) Pub. No.: US 2007/0174701 A1
(43) Pub. Date: Jul. 26, 2007

(54) Selective test method and test apparatus thereof

(75) Inventors: Jae-gap Lee, Seoul (KR); Ji-hyun Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/439,146

(22) Filed: May 24, 2006

(30) Foreign Application Priority Data
Dec. 21, 2005 (KR) 2005-126833

(51) Int. Cl. G06F 11/00

(52) U.S. Cl. 714/33

(57) ABSTRACT

A selective test method and an apparatus thereof are provided. The selective test method includes storing test information including one or more test cases implemented by a test script, if one of the test cases is selected, storing selected test information including the selected test case, comparing the stored test information with the stored selected test information, and if it is determined that the test information and the selected test information are identical, executing a test script corresponding to the selected test case. Therefore, an interface is provided for a user to easily recognize the test script so that a selective test can be executed by various cases without being dependent on a certain automatic test tool.

This application claims priority of Korean Patent Application No. 2005-126833 filed on Dec. 21, 2005, in the Korean Intellectual Property Office, the disclosure of which is incorporated herein by reference.

### BACKGROUND OF THE INVENTION

1. Field of the Invention

The present invention relates to a selective test method and a test apparatus thereof. More particularly, the present invention relates to a selective test method that executes a test only for a certain test case by selecting a test case not to be dependent on a certain automatic test tool when a test is executed by using an automatic test tool, and an apparatus thereof.

2. Description of the Related Art

Recently, a home network tends to be constructed in which electric appliances such as Internet refrigerators, videos and audios are connected over one network. Additionally, a home network has been gradually utilized in which communication media and security media in addition to the electric appliances are integrated and integrated managements can be performed by data communication over the network. In other words, the home network refers to a network over which information sharing and home automation can be implemented at home.

To implement the home network, the completion and standardization of related techniques are most important because the development of networking techniques, information electric appliances based on the networking techniques and the application software for smoothly operating the integrated circumstance should be together developed for the home network. Accordingly, it is also important to test whether devices constructing the home network are normally operated and whether the data communication is normally performed between devices.

FIG. 1 is a view for explaining a conventional selective test method.

Referring to FIG. 1, the scripts 1, 4, 5, 8 are for implementing control functions, and the scripts 2, 3, 6, 7 are for implementing memo functions. ‘Test Suite’ refers to a bundle of scenarios, and ‘Test Scenario’ refers to a plan for executing a test.

In detail, according to the conventional selective test method, the test is selected by a ‘test script’ unit that is managed by a certain automatic test tool. Then, the scenario constructed by the scripts 1, 4, 5 and 8 should be made and the scripts 1, 4, 5 and 8 should be individually added to the existing ‘Test Suite’ to test a product control function. Accordingly, the conventional method is inefficient and dependent on a certain automatic test tool because a scenario should be newly made or the existing scenario should be changed in order to execute a selective test for different cases from existing cases.

According to the conventional selective test method, the test is selected by a script unit; however, the information on the test case implemented by the script is not stored. In other words, a user should search the script and find the script corresponding to the case of interest to execute the selective test. Accordingly, inconveniences of users increase and it is difficult for an amateur user to recognize the script. Additionally, it is impossible to execute a selective test for various cases.

### SUMMARY OF THE INVENTION

Accordingly, aspects of the present invention are to address at least the above problem. Therefore, an aspect of the present invention is to provide a selective test method that divides a test script into various cases which can be easily recognized by a user to execute a test for a selective case.

Another aspect of the present invention is to provide a selective test method that is not dependent on a certain automatic test tool so as to execute a selective test according to various cases.

According to an aspect of the present invention, a selective test method includes operations of storing test information including one or more test cases implemented by test scripts, if one of the test cases is selected, storing selected test information including the selected test case, comparing the stored test information with the stored selected test information, and if it is determined that the test information and the selected test information are identical, executing a test script corresponding to the selected test case.

The test cases may be for determining a test script to be executed among the test scripts and include at least one of a test priority, a test function, a test type and a tester-in-charge.

When the test information and the selected test information are identical, it may be determined that the test script exists corresponding to the selected test case among the test scripts.

According to an aspect of the present invention, a test apparatus includes a storage part storing test information and selected test information, and a control part, if at least one of the test information including one or more test cases implemented by test scripts and the test case is selected, storing into the storage part the selected test information including the selected test case, and comparing the stored test information with the stored selected test information to execute a test script corresponding to the selected test case if it is determined that the test information and the selected test information are identical.

The test cases may be for determining a test script to be executed among the test scripts and include at least one of a test priority, a test function, a test type and a tester-in-charge.

The control part may determine that the test script exists corresponding to the selected test case among the test scripts when the test information and the selected test information are identical.

The test apparatus may further include a test case management (TCM) part to transmit the test information including the test cases implemented by the test script to the control part.

The test apparatus may further include a display part to display a test selection interface for selecting the test cases, and the control part may provide the test selection interface to the display part.

### BRIEF DESCRIPTION OF THE DRAWINGS

The above aspects and features of the present invention will be more apparent by describing certain non-limiting embodiments of the present invention with reference to the accompanying drawings, in which:

FIG. 1 is a view for explaining a conventional selective test method;

FIG. 2 is a block diagram of a test apparatus according to a non-limiting embodiment of the present invention;

FIG. 3 is a view of a test selection interface provided by a test apparatus according to a non-limiting embodiment of the present invention; and

FIG. 4 is a flowchart of a selective test method of a test apparatus according to a non-limiting embodiment of the present invention.

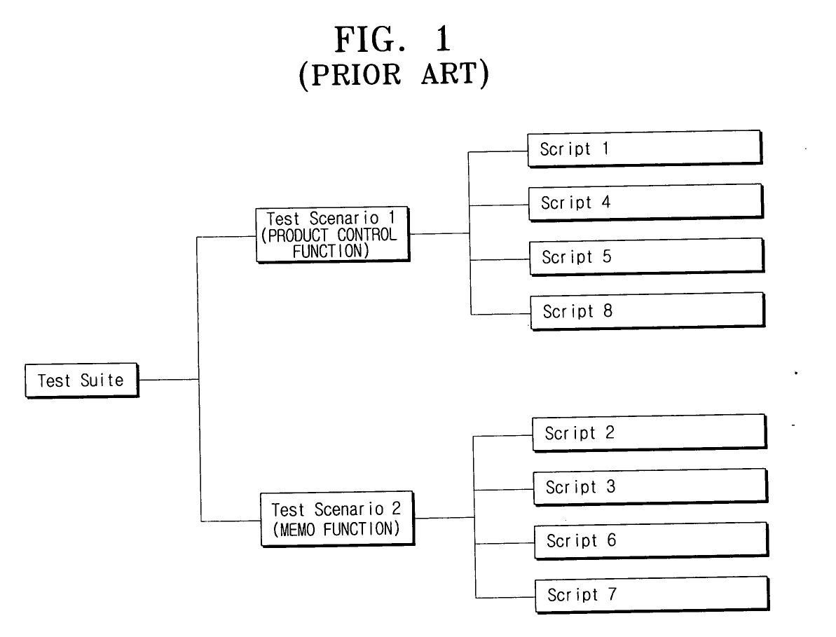

### DETAILED DESCRIPTION OF THE EXEMPLARY EMBODIMENTS

Exemplary, non-limiting embodiments of the present invention will be described in detail with reference to the annexed drawings. In the drawings, the same elements are denoted by the same reference numerals throughout the drawings. In the following description, detailed descriptions of known functions and configurations incorporated herein have been omitted for conciseness and clarity.

FIG. 2 is a block diagram of a test apparatus according to a non-limiting embodiment of the present invention.

A test apparatus 200 divides an exterior device 100 and a test script into various cases that can be easily recognized by a user and provides a user interface (UI) to select a test for the divided various cases. The test script is for testing data communication with the exterior device 100.

The test apparatus 200 determines if the test information corresponding to the case selected by a user is identical with the test information implemented by the test script of the exterior device 100 to execute a selective test.

Here, the exterior device 100 is at least one of devices constructing the home network, and for example, may be one of various electric appliances, home server and home gateway.

Referring to FIG. 2 the test apparatus 200 comprises an interface part 210, a display part 220, a selection part 230, a test case management (TCM) part 240, a storage part 250 and a control part 260. The interface part 210 provides a communication interface to communicate data with the exterior device 100.

On the display part 220, a device selection interface is displayed for a user to select a device to test. On the display part 220, a test selection interface is also displayed for a user to select a test that is divided into various cases. The cases of test include priorities, functions, types of test and testers-in charge (hereinafter, called owner). Additionally, on the display part 220, information on whether the selected test is executed, the status of execution and the result of execution may be displayed.

The selection part 230 receives a device selection command via the device selection interface displayed on the display part 220 from a user. The selection part 230 also receives a test selection command via the test selection interface displayed on the display part 220 from a user.

The TCM part 240 manages test cases according to various devices and transmits the test case selected by the selection part 230 and corresponding to the exterior device 100, i.e., all the test scripts and the test information indicating the division cases of the test script, to the control part 260, which will be explained later. Table 1 shows an example of the test division cases implemented by the test script.

TABLE 1

| | | | | Tester-in- |
|---|---|---|---|---|
| | | | | charge |
| Script | Priority | Function | Types of test | (owner) |
| Script 1 | P1 | Product | Function | User 1 |
| | | control | | |
| Script 2 | P1 | Memo | Function | User 1 |
| Script 3 | P2 | Memo | Performance | User 2 |
| Script 4 | P3 | Product | Performance | User 3 |
| | | control | | |
| Script 5 | P3 | Product | Function | User 4 |
| | | control | | |
| Script 6 | P3 | Memo | Performance | User 5 |
| Script 7 | P2 | Memo | Function | User 3 |
| Script 8 | P1 | Product | Function | User 2 |
| | | control | | |

As shown in Table 1, each script is divided into test cases such as priorities, functions, types of test and testers-in-charge (owner).

The test script corresponding to the exterior device 100, the test information indicating the division cases of each test script and the selected test information input by the selection part 220 are stored into the storage part 250.

The control part 260 stores into the storage part 250 the test script corresponding to the exterior device 100 and the test information indicating the division cases of the test script, which are received from the TCM part 240.

The control part 220 displays on the display part 220 the test selection interface that can select the test divided by division cases of the test script. If the test selection command is received via the selection part 230 on the test selection interface, the control part 260 stores into the storage part 250 the selected test information corresponding to the received test selection command.

The control part 260 compares the test information stored in the storage part 250 with the selected test information to execute the test script corresponding to the identical information.

Accordingly, because the present test apparatus 200 is not dependent on a certain automatic tool, the test can be executed in a complicated test scenario in which various automatic tools should be executed differently according to the selected types of test.

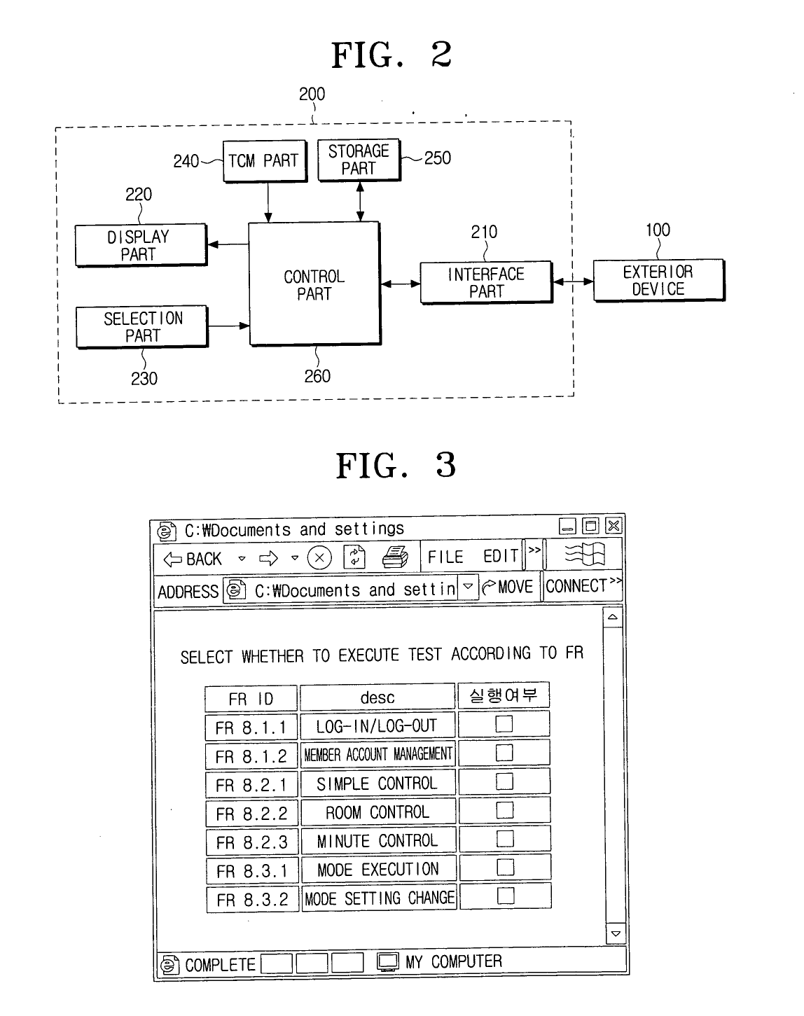

FIG. 3 is a view of a test selection interface provided by a test apparatus according to a non-limiting embodiment of the present invention.

As shown in FIG. 3, the test selection interface is displayed on the display part 220. The displayed test selected interface is for selecting minute functions when the function is selected among the test cases. The minute functions capable of executing a test include log-in/log-out, member account management, simple control, room control, minute control, mode execution and mode setting change.

If a user selects whether to execute a function from the minute function selection interface by using the selection part 230, the control part 260 stores into the storage part 250 the selected test information including the information on the function selected to be executed. For example, if ‘simple control’ is selected, the control part 260 generates a file including the information as below.

Function=FR 8.2.1

In other words, the generated file is stored as the selected test information into the storage part 250 to show function ID (FR ID) corresponding to ‘simple control’.

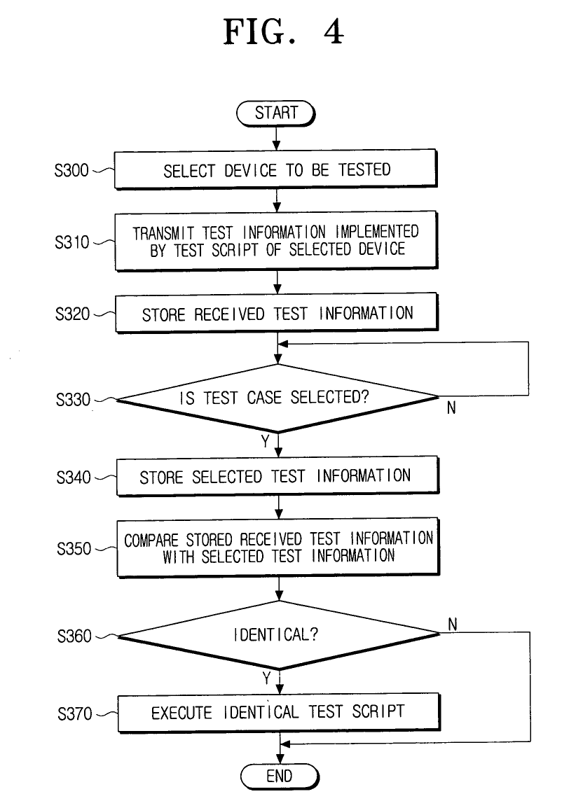

FIG. 4 is a flowchart for explaining a selective test method of a test apparatus according to an embodiment of the present invention.

Referring to FIG. 4, a user selects a device to be tested (S300). At this time, a user may select the exterior device 100 that will be tested in the device selection interface, or the control part 260 may automatically sense the exterior device 100 connected via the interface part 210.

The TCM part 240 transmits the test information implemented by the test script of the selected device to the control part 260 (S310). The control part 260 stores the received test information into the storage part 250 (S320). For example, the control part 260 stores the file having the test information including the division case of the test script 1 as below.

1 Priority = “P1”
1Fr = “product control”
1 Owner = “user 1”
1 Type = “function”

According to the test information, the priority of the test script 1 is priority 1 (P1), the function (Fr) is a product control, the tester-in-charger (owner) is user 1 and the type is a function.

Or, the operation of S300 of the selecting the device may be omitted, and if the operation of S300 is omitted, the TCM part 240 transmits the test information implemented by all the test scripts to the control part 260, and the control part 260 may store the received test information into the storage part 250.

The control part 260 determines if the test case is selected to decide the test to be executed (S330). At least one case can be selected among various test cases. At this time, the control part 260 can recognize that the test case is selected when whether to execute is selected from the test selection interface that can select the test, which is divided by the division cases of the test script.

If it is determined that the test case is selected (S330-Y), the control part 260 stores the selection test information including the selected test case into the storage part 250 (S340). In detail, the control part 260 generates and stores a file including the selected test information as below.

If key = “Priority” then

VPriority = value

elseif key = “Function” then

vFR=value

elseif key = “owner” then

vOwner = value

elseif key = “Type” then

vType = value

end if

Here, ‘key’ refers to the selected test case and ‘value’ refers to a value of the selected test case. In other words, if the selected test case is a priority, the value refers to a priority value of the selected test case, and if the selected test case is a function, the value refers to a type of the selected function.

The control part 260 compares the test information stored in the storage part 250 with the selected test information (S350). Then, the control part 260 determines if the test information is identical with the selected test information, i.e., if the test script corresponding to the selected test case exists (S360). The control part 260 compares the test information with the selected test information by using the following program to determine whether the information is identical and determines whether a test is executed according to whether the information is identical or not.

Dim isTestable
IsTestable = 1
if vPriority<>“ “ and 1Priority<>vPriority then

isTestable = 0

elseif vFr<>“ “ and 1Fr<>vFr then

isTestable = 0

elseif vOwner<>“ “ and 1Owner<>vOwner then

isTestable = 0

elseif vType<>“ “ and 1Type<>vType then

isTestable = 0

end if
if isTestable = 1 then

SQAConsoleWrite “test is executed”

else

SQAConsoleWrite “test is not executed”
goto endOfSub

end if

As described above, the control part 260 compares the test information with the selected test information to determine whether to execute the test. In detail, if the test information and the selected test information are identical, i.e., if the variable is 1, the control part 260 executes a test, and if the test information and the selected test information is not identical, i.e., if the variable is 0, the control part 260 does not execute a test. Additionally, the control part 260 outputs the information on whether to execute the test. If the variable is 1. “test is executed” is output, and if the variable is 0, “test is not executed” is output. The information is displayed on the display part 220.

If the test information and the selected test information are identical, i.e., if it is determined that the test script corresponding to the selected test case exists (S360-Y), the control part 260 executes the identical test script (S370). For example, if the selected test case is priority 1, the control part 260 executes the test scripts 1, 2 and 8 which have priority 1 as shown in Table 1.

Hitherto, the test cases implemented by the test script are divided by priorities, functions, types of test and testers-in-charge (owner). However, this should not be considered as limiting. The test cases can be more minutely divided.

As described above, according to an embodiment of the present invention, an interface is provided for a user to easily recognize the test script so that a selective test can be executed by various cases without being dependent on a certain automatic test tool.

While the invention has been shown and described with reference to certain non-limiting embodiments thereof, it will be understood by those skilled in the art that various changes in form and details may be made therein without departing from the spirit and scope of the invention as defined by the appended claims.

What is claimed is:

1. A selective test method comprising:
storing test information including one or more test cases implemented by test scripts;
selecting one of the test cases;
storing selected test information including the selected test case;
comparing the stored test information with the stored selected test information; and
if it is determined that the test information and the selected test information are identical, executing a test script corresponding to the selected test case.

2. The method as claimed in claim 1, wherein the test cases are for determining a test script to be executed among the test scripts and the test cases include at least one of a test priority, a test function, a test type and a tester-in-charge.

3. The method as claimed in claim 1, wherein when the test information and the selected test information are identical, it is determined that the test script corresponding to the selected test case exists among the test scripts.

4. A test apparatus comprising:
a storage part operative to store a plurality of test information and selected test information; and
a control part operative to store, in the storage part, selected test information including a selected test case, and operative to compare the stored test information with the stored selected test information to execute a test script corresponding to the selected test case if it is determined that the test information and the selected test information are identical.

5. The test apparatus as claimed in claim 4, wherein the test cases determine a test script to be executed among the test scripts and include at least one of a test priority, a test function, a test type and a tester-in-charge.

6. The test apparatus as claimed in claim 4, wherein the control part is operative to determine that the test script corresponding to the selected test case exists among the test scripts, when the test information and the selected test information are identical.

7. The test apparatus as claimed in claim 4, further comprising a test case management (TCM) part operative to transmit the test information, including the test cases implemented by the test script, to the control part.

8. The test apparatus as claimed in claim 4, further comprising a display part operative to display a test selection interface for selecting the test cases,
wherein the control part is operative to provide the test selection interface to the display part.

9. The test apparatus as claimed in claim 4, wherein the test information comprises one or more test cases implemented by test scripts.
